(19) United States
(12) Patent Application Publication
(10) Pub. No.: US 2008/0047652 A1
(43) Pub. Date: Feb. 28, 2008

(54) Component handling using adhesive-backed carrier tape

(76) Inventor: Charles Gutentag, Los Angeles, CA (US)

Correspondence Address: Law Firm of Peter V.D. Wilde, 301 East Landing, Williamsburg, VA, 23185, US

(21) Appl. No.: 11/471,136

(22) Filed: Jun. 20, 2006

(51) Int. Cl. B32B 37/00

(52) U.S. Cl. 156/64

(57) ABSTRACT

The specification describes an improved carrier tape conveying method and system for sprocket wheel driven adhesive-backed carrier tape. The system is designed for precision placement of components on the adhesive-backed carrier tape. Each time the carrier tape is advanced stepwise for placement of a component, the sprocket hole position is measured by a follower indexing sprocket wheel positioned at the point where components are placed. If a hole is misaligned, the indexing wheel senses the misalignment and produces a re-registration signal causing the tape to move the correct distance to align the sprocket hole with the intended position.

### FIELD OF THE INVENTION

This invention relates to handling, transporting, and storing electronic components using adhesive-backed carrier tape.

### BACKGROUND OF THE INVENTION

(Portions of the following background may not be prior art.)

In the manufacture of integrated circuit (IC) devices, the individual IC chips are typically processed as a batch on a large silicon wafer. Hundreds or thousands of IC chips may be processed on a single wafer. The wafer is moved between processing stations for oxidation, resist application, implantation, etching, etc. without the need to individually handle IC chips. At the conclusion of the wafer fabrication, the wafer is diced to singulate the individual IC chips. At this point it is necessary to provide means for handling and transporting the individual chips. This is routinely achieved by mounting the chips, one by one, on a carrier tape, with the carrier tape being a form of the familiar conveyor belt. The carrier tape is wound on a reel, and the reels may be stored, and transported between processing and assembly centers.

Carrier tapes come in several forms. A common version is a pocket tape wherein individual plastic pockets are formed on a long plastic tape. IC chips are carried loosely in the pockets. Typically a cover tape is provided to cover the pockets and retain the loose chips in the pocket. At the next pick/place station, the cover tape is peeled back and the chips are individually picked by the pick head and placed where needed for the next processing/assembly operation. In IC chip processing, this is typically an assembly and packaging facility where the chips are attached to leadframes, and then encapsulated to provide the finished device. It should be understood that this is but one of many actual, and potential, applications for carrier tape, and carrier tape conveyors.

Carrier tapes are typically provided with sprocket holes along one or both edges of the tape. The tapes are driven, as a conveyor belt, by sprocket wheels provided with sprocket pins that engage the sprocket holes. In such a system the tapes can be advanced and positioned with precision.

Storing and transporting small electrical components in the manner just described is relatively straightforward. However the pick and place operations used to “load” and “unload” the tape are not. The components come in a wide variety of shapes and sizes. When the components are very small, as in the case of state of the art IC chips, the pick and place tools must find the chip for the pick cycle. Sophisticated tools have been designed for the pick operation. Many of these use machine vision to find and orient the chips for picking and placing. This kind of tool enhancement is especially needed for pocket tape, where the chips are loosely held in the pockets of pocket tape, and the positions and orientation of the chips on arrival at the pick station varies significantly. While the tape itself can be positioned accurately, using the sprocket holes as registration means, the chips carried by the tape are not accurately positioned.

An improved version of carrier tape uses an adhesive backing on the tape. The advantages of this kind of carrier tape is that, due to the adhesive-backing, the chips remain in the position and orientation where they are placed. This presents a major advance for pick/place operations, since the chips can be precisely placed on the tape, and the pick tool knows where to find the chip on the next pick operation. A longstanding goal in pick/place tools is a so-called “blind pick”, where the pick tool head simply reaches into a fixed and repetitive position to pick the chips. If that goal is reached, the need for vision systems, or pick heads that rotate and adjust the x-y position to find and handle the chips, would be eliminated. A further advantage of adhesive-backed carrier tape is that the cover tape can be eliminated.

In spite of the advance represented by adhesive-backed carrier tape, when the IC chips are very small, as in state of the art devices, and the tolerances for pick and place are correspondingly reduced, existing tools for pick and place operations do not have the precision often needed for effective pick and place, and especially blind pick, operations. One property used to measure the precision of the pick and place operation is repeatability. This is the ability of index locations, after stepping the tape, or after demounting and remounting of carrier tape reels, to return and align to the original index locations. Typical carrier tapes and carrier tape conveyors in use currently have a repeatability of several mils.

It is important to recognize that, with standard types of carrier tape, this level of repeatability is adequate, and there is little motive to attempt to improve it. This is because many conventional carrier tape systems rely on vision systems or the like to locate the components as they reach a pick site. In such cases repeatability is not an issue.

With adhesive-backed carrier tape, blind pick at the pick sites is a realistic goal. However, with state of the art IC chips, for that goal to be realized effectively, repeatability of 10 microns or less is desirable. Current carrier tape conveying systems, do not reliably meet that degree of precision.

### BRIEF STATEMENT OF THE INVENTION

An improved carrier tape conveying system has been designed that has significantly improved repeatability. The improved conveying system may meet the goal of 10 micron or less repeatability. The improved conveying system is partly based on a novel analysis of carrier tape systems, and the recognition that a main barrier to precision repeatability is that the pitch of the sprocket holes varies due to unpredictable, or heretofore unrecognized, factors. Among these are the elasticity of the tape, and very small errors in the punch operation used to create the sprocket holes. To overcome these, according to the invention, the sprocket hole position is measured by an indexing sprocket wheel positioned at the point where components are placed. The indexing sprocket wheel has sprockets that engage the holes in the tape. If a hole is misaligned, the indexing wheel senses the misalignment and produces a re-registration signal causing the tape to advance or retreat the correct distance to move the sprocket hole to the intended position. In a preferred embodiment, the position error measurement is taken in advance of the position where the components are placed. In this way, the indexing sprocket wheel generates a signal for the corrected position and causes the tape to advance the adjusted increment.

### BRIEF DESCRIPTION OF THE DRAWING

The invention may be better understood when considered in conjunction with the drawing in which:

FIG. 1 is a schematic diagram of a punched, adhesive-backed, carrier tape;

FIG. 2 is a section view through 2-2 of FIG. 1;

FIG. 3 is a schematic diagram of a carrier tape conveyor system;

FIG. 4 illustrates an alternative arrangement of the carrier tape sprocket holes with respect to carrier tape compartments;

FIG. 5 is a diagram similar to that of FIG. 4 showing an error in component placement;

FIG. 6 is a schematic diagram of a carrier tape conveyor system with an indexing sprocket wheel according to the invention;

FIG. 7 is a schematic representation illustrating the relationship between the carrier tape sprocket holes and the indexing sprocket wheel;

FIG. 8 is a schematic view similar to FIG. 7 showing a misaligned carrier tape sprocket hole and the mechanism for sensing the misaligned hole by the indexing sprocket wheel;

FIG. 9 shows the feedback coupling between the indexing sprocket wheel and a carrier tape drive wheel; and

FIG. 10 is a view similar to that of FIG. 1 showing an alternative adhesive-backed carrier tape design.

### DETAILED DESCRIPTION OF THE INVENTION

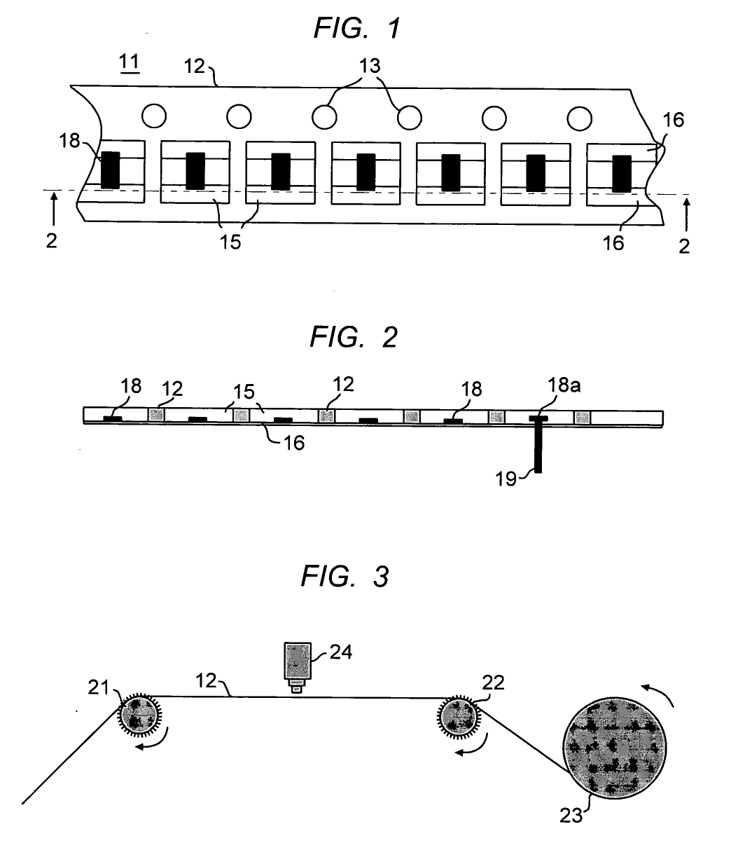

With reference to FIG. 1, an adhesive-backed carrier tape is shown generally at 11, comprising an endless plastic tape 12, sprocket holes 13 for driving and positioning the tape, carrier tape compartments 15, and the adhesive-backing 16. In this illustration the carrier tape compartments are shown loaded with IC chips 18. As indicated above, IC chips 18 are illustrative only of the kinds of parts and components that can be processed using the carrier tape conveyor system of the invention. The tape itself that comprises the adhesive-backed carrier tape is a relatively thick plastic endless strip with the sprocket holes punched through the thickness of the tape.

The adhesive-backed carrier tape is shown in cross section in FIG. 2. The view is taken through the compartments 15 so only the portions 12 of the tape, the portions separating the compartments, appears. The tape 12 is relatively thick, typically 0.1 to 1.0 mm, to provide a standoff for the compartments. The standoff is typically greater than the thickness of the components stored in the tape compartments so that the components are not touched and disturbed when the tape is reeled. The adhesive backing is shown at 16. As seen in FIG. 1, the adhesive backing is split into two rails. This allows the amount of adhesion between the carrier tape and the chips 18 to be varied depending upon the width of the adhesive tape rails 16. It also allows a pins to be inserted through the bottom of the carrier tape, to engage the chip 18 and aid in releasing the chip from the adhesive backing. These features are generally known and described for example in U.S. Pat. No. 5,203,143, which patent is incorporated herein by reference.

Carrier tape conveyor systems for adhesive backed carrier tapes are usually provided with an ejector pin. This is schematically illustrated in FIG. 2 where ejector pin 19 is one embodiment of a release device to aid in removing chip 18a from the adhesive backing of the carrier tape. The ejector pin operates in cooperation with the pick head (not shown in this figure). One reason for the split rail design for the adhesive tape, shown in FIG. 1, is evident here. Other types or forms of ejector mechanisms may be used. Typically, such an ejector mechanism will not be found associated with pocket tape conveyors since the components that are conveyed as floating objects in the carrier tape pockets are easily lifted from the tape by a vacuum pick tool.

The conveying apparatus for the adhesive-backed carrier tape is shown in FIG. 3. The illustration is for a component placement operation wherein the adhesive-backed carrier tape 12 is unreeled from a tape reel to the left of the figure (not shown), passed beneath a component placement head 24, and reeled onto tape reel 23. The apparatus is shown very schematically to indicate that a variety of mechanical implementations are possible for moving the carrier tape underneath the chip placement head. The details of the placement head are also not part of the invention. Pick heads and placement heads in pick and place tools are well known, and typically operate pneumatically to dispense chips individually onto the tape for the place operation, and to vacuum the chips individually from the tape on the pick operation. The drive wheels are shown at 21 and 22, and are sprocket wheels of general design. Wheels 21, 22, and 23 are coordinated for advancing the tape under the placement head 24. In some cases in the prior art, a single drive wheel may be used, with other guiding wheels provided as follower wheels. However, for reasons that will become apparent below, a preferred arrangement is to provide at least one drive wheel along the tape path on each side of the placement head 24. These wheels may be electromechanically coupled to allow the tape to be controllably driven in both the forward and the reverse directions. Moreover, two or more positive drive wheels help stabilize the movement and position of the tape.

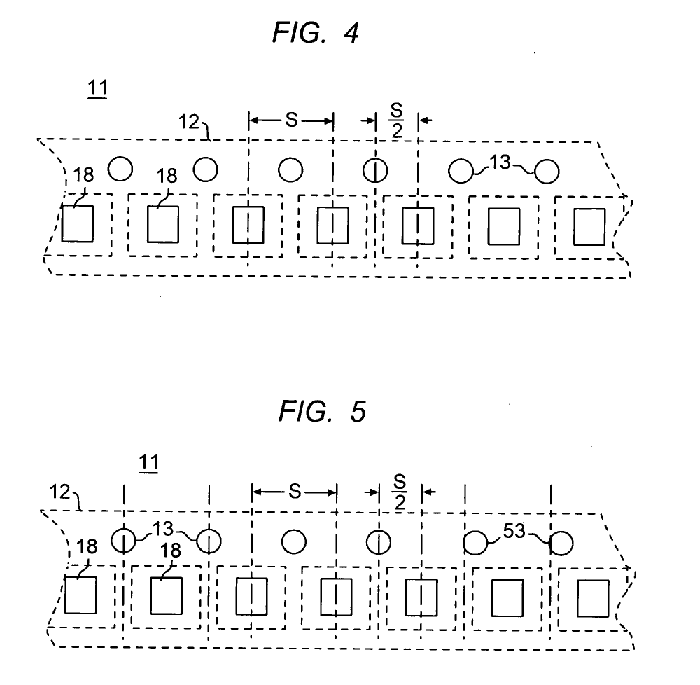

Referring to FIGS. 4 and 5, a potential error in the placement of the sprocket holes is illustrated. In these figures, as well as in FIG. 1, each chip is placed equidistant between two sprocket holes. In an alternative arrangement (not shown) each chip may be placed precisely next to a sprocket hole. It should be understood that these options are but two of many that may be used. However, it is important that some repeatable relationships exist between the placement of the chips and the location of an identifiable sprocket hole. This relationship may be required for implementing a blind pick in a future operation. A future operation may be a pick downstream of the placement on the conveyor path, a part of which is shown in the figure, or may be a pick operation after the tape is reeled, stored or transported, and unreeled.

FIG. 4 shows proper and uniform locations for the sprocket holes 13. The sprocket holes 13 are spaced at distance S, and the compartments or chips are placed in between the sprocket holes at distance S/2 as shown. FIG. 5 illustrates a typical case addressed by the invention, where sprocket holes 53 are displaced from the proper position. In most conveyor tape apparatus, the pitch of the sprocket holes is intended to be fixed. The pitch of the sprocket holes is engineered to match the pitch of the spokes on the carrier tape drive wheels. The sprocket wheel and spokes are made of rigid metal, and the pitch of the sprockets will not vary. However, the pitch of the sprocket holes in the tape may vary due to several causes. One, the carrier tape is plastic, and the carrier tape may stretch uncontrollably. Also, errors in punching the sprocket holes cause errors in sprocket hole pitch. A common method of punching sprocket holes in carrier tape is to use a punch die with many, for example 12, hole punches aligned in a row. Un-punched tape is advanced to beneath the punch die, and a group of 12 holes are punched simultaneously. The hole-to-hole spacing in the group of 12 holes is precise because of the accuracy of the hole spacing in the metal punch die. The tape is then advanced 12 positions and another group of reliably spaced holes are punched. However, each time the tape is advanced 12 positions for the next group punch, there is a potential registration error between groups of punched holes because the tape may advance 12 positions ± several or many microns. That results in a pitch error between the 12th and 13th sprocket hole, the 25th and 26th sprocket hole, and so on.

Pitch errors are commonly overlooked in conventional carrier tape conveying systems. That is especially the case with pocket tape conveying systems because in those systems pitch error is inconsequential, as explained earlier.

According to the invention, pitch errors in the carrier tape are measured each time a chip is placed. This is counter to many conventional systems wherein the pick operation, not the place operation, is highly engineered for accuracy. It is important to measure the pitch errors at a position close to the placement head to account for tape stretching that occurs upstream of the placement position.

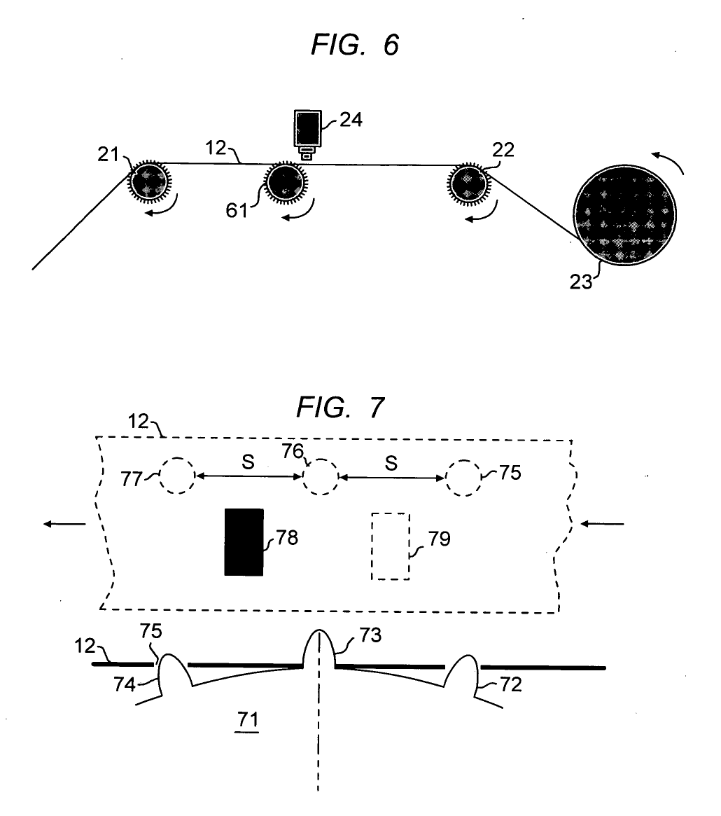

In a carrier tape conveyor system used according to the invention, an indexing sprocket wheel is located near the chip dispensing head. This is illustrated in schematically in FIG. 6. The tape conveyor system in FIG. 6 will be recognized as similar to the tape conveyor system of FIG. 4, but with indexing sprocket wheel 61 added at a position proximate the chip placement head 24. It would appear to be convenient to locate the indexing sprocket wheel 61 at the precise position of the placement head, and measure, and adjust if necessary, the location of the chip placement. However, the location of a sprocket hole one hole (or a few holes) upstream may be measured while the placement tool is placing a chip. The tape may be stepped the proper distance for each placement, i.e., each chip is stepped the nominal pitch distance plus or minus the measured error. It is then unnecessary to adjust the position of the carrier tape after each step.

It should be apparent that the indexing sprocket wheel is a follower wheel, used for measuring sprocket hole positions. The drive wheels are wheels 21 and 22. The indexing sprocket wheel and the drive wheels are associated electronically, as will be described below, but not mechanically. The indexing sprocket wheel and the drive wheels are arranged to turn independently.

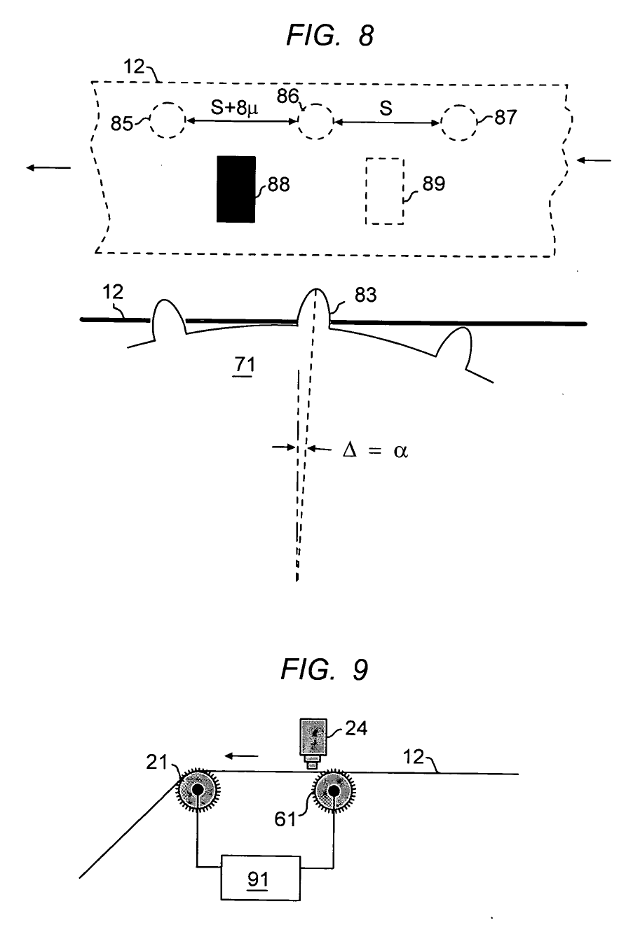

The operation of the indexing sprocket wheel is shown in greater detail in FIGS. 7 and 8. In both figures, the indexing sprocket wheel is shown at 71, and the tape 12 in this illustration is moving right to left in the direction of the arrows. The figure shows chip 78 already placed in position by the placement device. The placement device is located in the position represented by chip 78. The figures show tape 12 edgewise, engaging the indexing sprocket wheel, and also in plan view (in phantom) above. FIG. 7 illustrates a properly spaced hole, i.e., all holes are on-pitch, the pitch being S (plus the nominal hole diameter), where, when sprocket pin 73 in the indexing sprocket wheel 71, is engaged with sprocket hole 76, the sprocket pin 73 is in the precisely vertical position. At this point there are two optional modes of operation to be described. One is a variable step method, where each step is predetermined with the position error accounted for. The other uses a fixed step, and an adjustment back or forth after the step is completed. FIG. 7 describes either method. If the carrier tape is stepped by a fixed step distance equal to pitch S (plus nominal hole diameter), the indexing sprocket wheel has determined that sprocket hole 76 is in the proper location. Therefore, when the carrier tape is advanced by a fixed step S (plus nominal hole diameter), to the position of the placement head (position 78), the placement of the next chip will be precisely correct. If the variable step method is used, the system in FIG. 7 has determined that the correct step distance is equal to the pitch distance S, and again the next chip placement will be precisely correct. The chip placement will be precisely in position 79, i.e. registered with sprocket hole 76. At this particular step in the carrier tape advancement sequence, the sprocket hole 76 may be considered the indexing sprocket hole for purposes of definition.

FIG. 8 illustrates how the indexing sprocket wheel, in cooperation with the conveyor tape drive, performs a hole position error correction. In the illustration of FIG. 8, chip 88 is already placed in a proper location aligned with sprocket hole 85. However, when the tape is advanced one position, i.e. advanced by a distance equal to the pitch of the sprockets on the sprocket wheel, sprocket hole 86 is out of place. Due to a sprocket hole pitch error, the space between sprocket holes 85 and 86 is 8 microns greater than the nominal pitch S. The indexing sprocket wheel senses this error because the angle that sprocket 83 makes with a vertical is not zero as expected, but is off by angle α. In the case given, angle α is equivalent to a linear displacement of 8 microns. This relationship can be established empirically, or calculated by:

tan α=x/D
where D is the diameter of the sprocket wheel.

Using the variable step method, the error in the sprocket hole position is sensed by the under rotation of the indexing wheel and the corrected step distance, S+8 microns is calculated. Then the drive wheel is directed to advance the tape by the corrected step distance. That results in sprocket hole 86 being properly placed so that the placement, at location 88, will be precisely that shown in phantom at 89. Using the fixed step method, the sprocket wheel 71 is in the position shown in FIG. 8, the angular error in the wheel position is sensed and the drive apparatus is directed to move the wheel so that sprocket pin 83 is in the precisely vertical position. Then the carrier tape is advanced by the fixed distance S and the component 89 is placed.

While the corrected angular position in this illustration is referenced to the vertical, the apparatus can be engineered for other reference positions. Whatever base position is used, the deviation from that base position is referred to here as the deviation angle (α in FIG. 8).

A schematic feedback circuit is shown in FIG. 9. Both the indexing sprocket wheel 61 and the drive mechanism 21 are shown connected to control apparatus 91. The control apparatus receives data on the rotational position of the indexing sprocket wheel. The combination of the indexing sprocket wheel and the control apparatus compares the measured position of the indexing sprocket wheel with the desired position, and generates an error signal corresponding to the sprocket hole position error. It then directs the drive mechanism to advance (or adjust) the tape in accordance with the description above. For reasons mentioned earlier, it is preferred that the indexing sprocket wheel engage the tape in the proximity of the placement device 24. For example, both the placement head 24 and the reference sprocket are within 10 L, and preferably within 3 L, where S is the nominal pitch of the sprockets in the sprocket tape. With the arrangement shown in FIG. 1, using a minimum distance between the reference sprocket and the placement, and using vertical as the reference angle, would result in having the placement head located at 0.5 S with respect to the reference sprocket hole. In the arrangement just shown, i.e. FIGS. 7 and 8, the separation is S/2. The separation may also be zero.

It is also preferred that the reference hole is the trailing hole when the tape is in the feeder for device placement and then the leading hole when the tape is in the feeder for component pick.

In an apparatus of the kind described here, the drive sprocket wheel is conventionally operated using a servo motor. The rotational position of the indexing drive wheel may be measured by a variety of means, either (or both) electrical or optical. In the preferred case, the rotational position of the indexing wheel will be indicated by an electrical signal, and the electrical signal will be used to rotate the drive sprocket wheel by the desired amount to effect the correction. In the case of the fixed step with adjustment, rotation may be either clockwise or counterclockwise to move the tape forward or in reverse.

The conveyor tape apparatus described here is capable of registering IC chips or other components with a tolerance of 10 microns or less, and preferably 5 microns or less. This allows the pick operation to be made “blind”, i.e. without a separate tool used to locate the chip prior to the pick. Tolerance means that the components are registered to the center of each sprocket hole within ±10 microns, or ±5 microns.

In the description above, the carrier tape conveying apparatus and placement head are designed to place a component at a position aligned beside each hole. However, with reference to FIG. 1 for example, it should be clear that a variety of spatial relationships between the holes and the component placement are suitable. In FIG. 1, the component placement is centered on a line between each hole. In most cases it is recommended that the component placement have a predetermined position with respect to the nearest, that is the adjacent, hole, or with either of two equally proximate holes (FIG. 1).

The adhesive-backed carrier tape is shown in the figures with separate compartments 15 for each chip. Alternatively, the compartments may be omitted, and a flat strip with adhesive regions corresponding to the compartments may comprise the adhesive carrier tape.

In the arrangement shown in FIG. 6, the indexing sprocket wheel 61 is described as a follower wheel, with sprocket wheels 21 and 22 performing the tape drive function for both the stepwise advancement of the carrier tape as well as any sprocket hole position adjustment. However, the rotational adjustment shown in FIG. 8 can alternatively be effected by driving indexing wheel 71 to the vertical position thereby moving the carrier tape to the proper position for placement. The drive wheel(s) may be disengaged (or partially disengaged) temporarily to allow the indexing wheel to move the tape. In this implementation, the error correction signal, generated by a measurement of the rotational position of the indexing drive wheel, is not needed. The indexing sprocket wheel itself may be provided with an adjustment drive means, activated after each stepwise movement of the carrier tape, to return the reference sprocket hole to the reference position (e.g. vertical).

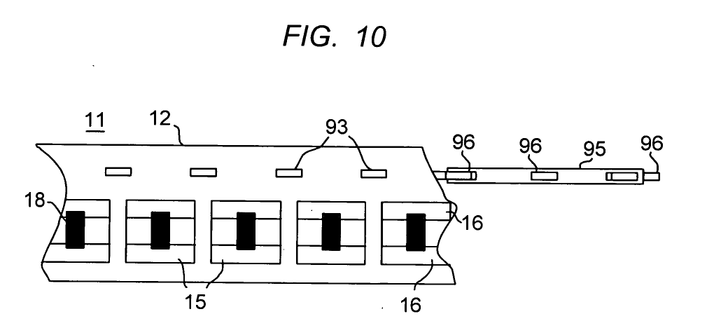

Most carrier tapes in use currently have sprocket holes that are round. It is intuitively evident that round sprocket holes in the carrier tape and round sprockets facilitates engagement between these elements partly because it provides an allowance for slight tape rotation in the x-y plane. However, in a precision system of the kind described here, that rotational allowance may not be an advantage. FIG. 10 shows an adhesive backed carrier tape in which the sprocket holes 93 are rectangular. The sprockets 96 on the sprocket wheel 95 have a corresponding shape. In this design the sprockets and sprocket holes cooperate to stabilize the tape in the x-y plane, and increase the accuracy and repeatability of the position of the tape. While not shown (for clarity) the sprockets 96 may have tapered sides to aid in engagement with sprocket holes 96. Whereas the shape of the sprocket holes in FIG. 10 is rectangular, other polygon shapes, regular or irregular, may provide equivalent or similar advantages. Additionally, while the rectangular slots in the carrier tape shown in FIG. 10 extend along the length of the carrier tape, they may be rotated 90 degrees and extend across the width of the carrier tape.

Carrier tape conveyor systems for adhesive backed carrier tapes are usually provided with an ejector pin. This is illustrated in FIG. 2, where ejector pin 19 is shown aiding in the displacement and pick of chip 18a. The ejector pin is located so that when actuated it extends through the split in the carrier tap rails.

Various additional modifications of this invention will occur to those skilled in the art. All deviations from the specific teachings of this specification that basically rely on the principles and their equivalents through which the art has been advanced are properly considered within the scope of the invention as described and claimed.

1. Method for placing components on an adhesive-backed carrier tape using a placement head activated to dispense components individually on the carrier tape in response to movement of the carrier tape, wherein the carrier tape contains sprocket holes on a given nominal pitch S comprising the steps of:
a. moving the adhesive-backed carrier tape along a path next to the placement head,
b. stopping the tape with a reference sprocket hole proximate the placement head,
c. measuring the position of the reference sprocket hole,
d. comparing the position of the reference sprocket hole with a desired position,
e. moving the tape to align the reference sprocket hole with the desired position, and
f. activating the placement head to place a component on the adhesive-backed carrier tape in a predetermined position with respect to the reference sprocket hole.

2. The method of claim 1 wherein the predetermined position is within 3 L of the reference sprocket hole.

3. The method of claim 1 wherein the predetermined position is adjacent the reference sprocket hole.

4. The method of claim 1 wherein the measurement is made using an indexing sprocket wheel.

5. The method of claim 1 wherein in step e. the carrier tape is moved forward or in reverse.

6. The method of claim 4 wherein the carrier tape is moved by a drive sprocket wheel, and steps a. and b. are alternated to produce stepwise movement of the carrier tape with the stepwise movement determined by rotation of the drive sprocket wheel.

7. The method of claim 6 wherein:
steps c. and d. are performed to determine a corrected stepwise movement to advance the tape and correctly position the reference sprocket hole with respect to the placement head, and
the drive sprocket wheel is rotated to advance the carrier tape by the corrected stepwise movement.

8. The method of claim 6 wherein the drive sprocket wheel is rotated in response to a signal generated by the indexing sprocket wheel to effect step e.

9. A carrier tape conveying system comprising:
a. a drive sprocket wheel for moving a carrier tape along a carrier tape path, the sprockets in the drive sprocket wheel having a pitch S,
b. a placement head located next to the carrier tape path for placing electrical components on the carrier tape,
c. an indexing sprocket wheel, the sprockets in the indexing sprocket wheel having a pitch S, the indexing sprocket wheel being free to rotate independently of the drive sprocket wheel, and positioned:
1. to engage sprocket holes in the carrier tape, and
2. within a distance 3S of the placement head,
d. a controller associated with both the indexing sprocket wheel and the drive sprocket wheel for rotating the drive sprocket wheel in response to a signal indicating the rotational position of the indexing sprocket wheel.

10. The carrier tape conveying system of claim 9 wherein the indexing sprocket wheel and the placement head are essentially co-located.

11. The carrier tape conveying system of claim 9 wherein the drive sprocket wheel is driven in both clockwise and counterclockwise rotation.

12. A carrier tape conveying system comprising:
a. a drive sprocket wheel for moving a carrier tape along a carrier tape path, the sprockets in the drive sprocket wheel having a pitch S,
b. a placement head located next to the carrier tape path for placing electrical components on the carrier tape,
c. an indexing sprocket wheel, the sprockets in the indexing sprocket wheel having a pitch S, the indexing sprocket wheel being free to rotate independently of the drive sprocket wheel, and positioned:
1. to engage sprocket holes in the carrier tape, and
2. within a distance 3S of the placement head,
d. an adjustment means acting on the indexing sprocket wheel to drive the indexing sprocket wheel to a reference position.

13. The carrier tape conveying system of claim 1 wherein the sprockets have a polygon shape.

14. The carrier tape conveying system of claim 9 wherein the sprockets have a polygon shape.

15. The carrier tape conveying system of claim 12 wherein the sprockets have a polygon shape.

16. The carrier tape conveying system of claim 12 wherein the indexing sprocket wheel is positioned to engage a sprocket hole in the carrier tape within S/2 of the placement head.
